(19) United States
(12) Patent Application Publication
(10) Pub. No.: US 2007/0070036 A1
(43) Pub. Date: Mar. 29, 2007

(54) ELECTRONIC PRESENTATION CONTROL DEVICE, SYSTEM AND METHOD

(75) Inventors: MING-CHAO HUANG, Tu-Cheng (TW); JR-FU JUANG, Tu-Cheng (TW); HUNG-PING YU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/306,540

(22) Filed: Dec. 31, 2005

(30) Foreign Application Priority Data
Sep. 23, 2005 (TW) 94133081

(51) Int. Cl. G09G 5/00

(52) U.S. Cl. 345/156

(57) ABSTRACT

An electronic presentation control device (100) includes a keyboard module (110), a command encoding module (120), an electronic presentation control module (130), and a wireless communication module (140). The keyboard module is provided for inputting information. The command encoding module encodes the input information into control information. The wireless communication module communicates with a communication port of a computer via a wireless local area network. The electronic presentation control module inputs the control information to the communication port of the computer and controls an electronic presentation application of the computer. An electronic presentation control system and method are also provided.

### FIELD OF THE INVENTION

The invention relates to electronic control systems, and particularly to an electronic presentation control device, system and method.

### DESCRIPTION OF RELATED ART

Slide projectors are commonly used for displaying images during presentations such as at business or academic forums. With the growing popularity of computers, presentation software is now frequently used in conjunction with a computer's data storage for creating material including images and conducting presentations. Slide projectors are thus gradually being replaced by computers and associated projectors.

In a conventional computer-based projection system, a presentation controller is composed of a presentation signal transmitter and a presentation signal receiver. The presentation signal receiver is electronically connected to the computer, and receives wireless signals transmitted by the presentation signal transmitter to the computer.

However, the conventional presentation controller needs a proprietary presentation signal transmitter, and a presentation signal receiver compatible with the corresponding projector or slide-presentation program. The extra cost of the transmitter and the receiver can be high. Moreover, a presenter needs to install the transmitter and the receiver before giving a presentation, which can be unduly inconvenient.

### SUMMARY OF THE INVENTION

An exemplary embodiment of the present invention provides an electronic presentation control device. The electronic presentation control device includes a keyboard module, a command encoding module, a wireless communication module, and an electronic presentation control module. The keyboard module is used for inputting information. The command encoding module is used for encoding the input information into control information. The wireless communication module is used for communicating with a communication port of a computer via a wireless local area network. The electronic presentation control module is used for inputting the control information to the communication port of the computer and controlling an electronic presentation application of the computer.

Another exemplary embodiment of the present invention provides an electronic presentation control system. The electronic presentation control system includes a computer and an electronic presentation control device. The computer includes an electronic presentation application and a communication port. The electronic presentation application is used for displaying an electronic presentation. The electronic presentation control device includes a keyboard module, a command encoding module, a first wireless communication module, and an electronic presentation control module. The keyboard module is used for inputting information. The command encoding module is used for encoding the input information into control information. The first wireless communication module is used for communicating with the communication port of the computer via a wireless local area network. The electronic presentation control module is used for inputting the control information to the communication port of the computer and controlling the electronic presentation application of the computer. The computer receives the modified control information, reads the control information from the communication port, and executes corresponding commands to control the electronic presentation application.

Still another exemplary embodiment of the present invention provides an electronic presentation control method. The electronic presentation control method includes the steps of: executing a drive application on a computer to actuate a communication port of the computer; providing an electronic presentation control device for executing an electronic presentation control application; setting an internet protocol address and the communication port of the computer; connecting the electronic presentation control device and the computer via a wireless communication network; inputting the control information via the electronic presentation control application to the communication port; transmitting modified control information from the electronic presentation control device via the wireless communication network to the computer; and receiving the modified control information, the drive application reading the control information from the communication port, and executing corresponding commands to control an electronic presentation application of the computer.

Other advantages and novel features will become more apparent from the following detailed description when taken in conjunction with the accompanying drawings, in which:

### BRIEF DESCRIPTIONS OF THE DRAWINGS

FIG. 1 is a block diagram of an electronic presentation control system of an exemplary embodiment of the present invention;

FIG. 2 is a schematic diagram of functional modules of an electronic presentation control device and a computer of the system of FIG. 1;

FIG. 3 is a flowchart of an electronic presentation control method of another exemplary embodiment of the present invention; and

FIG. 4 is a block diagram of an electronic presentation control system of a further exemplary embodiment of the present invention.

### DETAILED DESCRIPTION

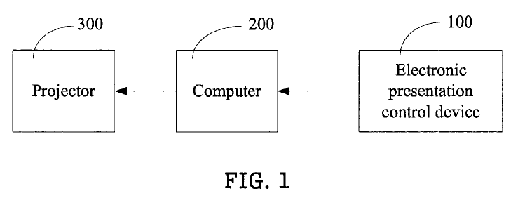

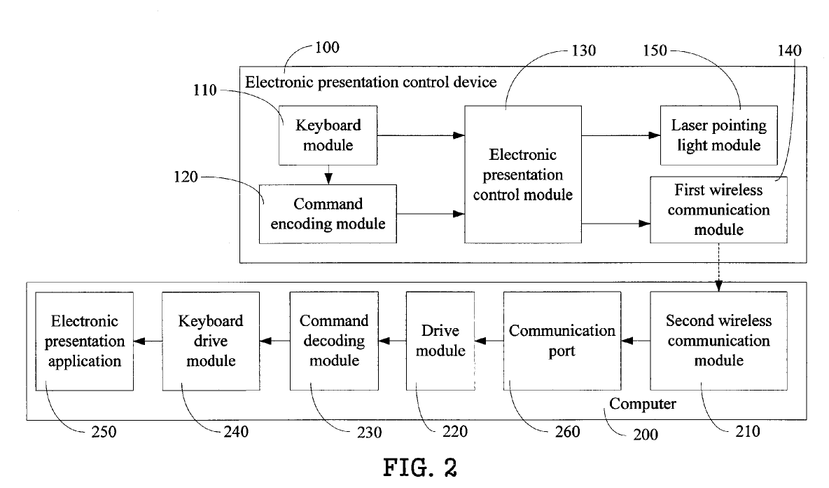

FIG. 1 is a block diagram of an electronic presentation control system of an exemplary embodiment of the present invention. In the exemplary embodiment, the electronic presentation control system includes an electronic presentation control device 100, a computer 200, and a projector 300. The electronic presentation control device 100 may be a mobile phone, a personal digital assistant (PDA), or another kind of mobile communication device. The electronic presentation control device 100 and the computer 200 are connected via a wireless local area network. In addition to performing its normal functions as a mobile phone, PDA etc, the electronic presentation control device 100 can be used for controlling an electronic presentation application 250 of the computer 200 (see FIG. 2). The projector 300 is used for projecting presentation information of the electronic presentation application 250 of the computer 200. In the exemplary embodiment, after the electronic presentation control device 100 and the computer 200 are connected via the wireless local area network, and the electronic presentation control device 100 sets an internet protocol (IP) address and a communication port 260 of the computer 200 (see FIG. 2), the electronic presentation device 100 can communicate with the computer 200. Thus, the electronic presentation control device 100 can transmit control information to the computer 200. The computer 200 receives the control information and executes corresponding commands to control the electronic presentation application 250 of the computer 200.

FIG. 2 is a schematic diagram of functional modules of the electronic presentation control device 100 and the computer 200. In the exemplary embodiment, the electronic presentation control device 100 includes a keyboard module 110, a command encoding module 120, an electronic presentation control module 130, a first wireless communication module 140, and a laser pointing light module 150. In another exemplary embodiment, the electronic presentation control device 100 does not include the laser pointing light module 150. The keyboard module 110 is used for inputting information. In the exemplary embodiment, the keyboard module 110 includes at least four directional keys for inputting the information. The input information includes a plurality of commands including first page, last page, next page, and previous page, corresponding to the electronic presentation application 250 of the computer 200. In another exemplary embodiment, the keyboard module 110 is also used for inputting other information, such as a command to skip a page and other kinds of commands.

The command encoding module 120 is used for encoding the information inputted by the keyboard module 110 into control information. In the exemplary embodiment, the command encoding module 120 includes America Standard Code for Information Interchange (ASCII), for transforming the input information into the control information. In another exemplary embodiment, the command encoding module 120 may include other encoding means for transforming the input information into the control information.

The first wireless communication module 140 is used for communicating with the communication port 260 of the computer 200 via the wireless local area network. The electronic presentation control module 130 is used for inputting the control information to the communication port 260 of the computer 200 and controlling the electronic presentation application 250 of the computer 200. The electronic presentation control module 130 is further used for transmitting the modified control information to the computer 200 via the first wireless communication module 140. In the exemplary embodiment, the electronic presentation control module 130 includes an electronic presentation control application. After the electronic presentation control device 100 executes the electronic presentation control application, the electronic presentation control device 100 can control the electronic presentation application 250 of the computer 200 via the wireless local area network, and can also control the laser pointing light module 150 to emit light, both by use of the keyboard module 110.

The laser pointing light module 150 is controlled by the keyboard module 110 and the electronic presentation control module 130 for emitting light on a display screen aimed at by the projector 300. In the exemplary embodiment, the laser pointing light module 150 comprises a Light Emitting Diode (LED). The LED can emit light when a user presses a corresponding control key or any suitable key of the keyboard module 110 after the electronic presentation control device 100 executes the electronic presentation control application of the electronic presentation control module 130. In another exemplary embodiment, the laser pointing light module 150 may comprise a laser diode or another kind of light source.

The computer 200 is used for receiving the modified control information and executing corresponding commands to control the electronic presentation application 250 of the computer 200. In the exemplary embodiment, the computer 200 includes the communication port 260, a second wireless communication module 210, a drive module 220, a command decoding module 230, a keyboard drive module 240, and the electronic presentation application 250 (for example, PowerPoint of Microsoft®). The second wireless communication module 210 is used for receiving the modified control information via the wireless local area network. The drive module 220 includes a drive application for actuating the communication port 260 and reading the control information from the communication port 260. The command decoding module 230 is used for decoding the control information into the original input information. The keyboard drive module 240 is used for analyzing the input information and executing corresponding commands to control the electronic presentation application 250. In the exemplary embodiment, the electronic presentation application 250 executes the commands according to the input information, the commands including first page, last page, next page, and previous page. In another exemplary embodiment, the electronic presentation application 250 may execute other commands according to other input information.

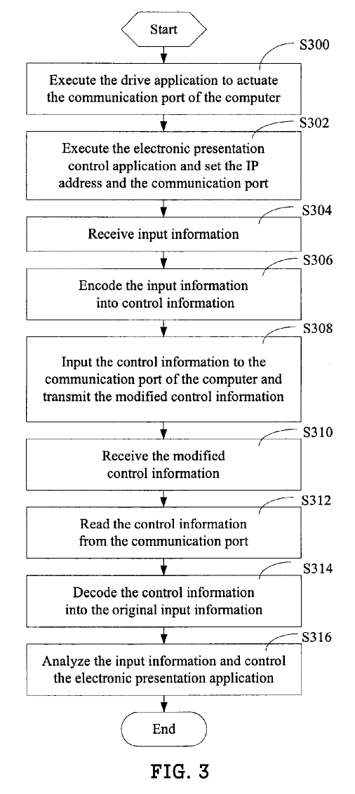

FIG. 3 is a flowchart of an electronic presentation control method of an exemplary embodiment of the present invention. In the exemplary embodiment, the electronic presentation control device 100 is used for controlling the electronic presentation application 250 of the computer 200 when a presenter conducts a presentation.

In step S300, the computer 200 executes the drive application of the drive module 220 to actuate the communication port 260 of the computer 200. In step S302, the electronic presentation control device 100 executes the electronic presentation control application of the electronic presentation control module 130, and sets the IP address and the communication port 260 of the computer 200 via the keyboard module 110. Thus, the electronic presentation control device 100 can communicate with the computer 200 via the wireless local area network. That is, after the setting is completed, the electronic presentation control device 100 can transmit control information to the computer 200 to control the electronic presentation application 250 of the computer 200.

In step S304, the keyboard module 110 receives input information, and transmits the input information to the command encoding module 120. In step S306, the command encoding module 120 encodes the input information into control information, and then transmits the control information to the electronic presentation control module 130. In step S308, the electronic presentation control module 130 inputs the control information via the electronic presentation control application to the communication port 260 of the computer 200, and transmits the modified control information to the computer 200 via the first wireless communication module 140.

In step S310, the second wireless communication module 210 of the computer 200 receives the modified control information via the wireless local area network. In step S312, the drive module 220 reads the control information from the communication port 260 via the drive application, and transmits the control information to the command decoding module 230. In step S314, the command decoding module 230 decodes the control information into the original input information, and then transmits the input information to the keyboard drive module 240. In step S316, the keyboard drive module 240 analyzes the input information and executes corresponding commands to control the electronic presentation application 250.

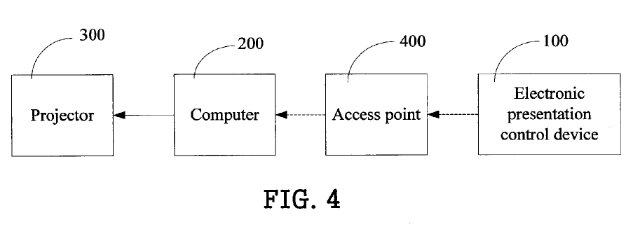

FIG. 4 is a block diagram of an electronic presentation control system of another exemplary embodiment of the present invention. In the exemplary embodiment, the electronic presentation control system includes the electronic presentation control device 100, the computer 200, the projector 300, and an access point 400. The exemplary embodiment is similar to the system of the previous embodiment described above; the difference being that the access point 400 wirelessly interconnects the electronic presentation control device 100 and the computer 200. That is, the electronic presentation control device 100 communicates with the computer 200 via the access point 400.

The electronic presentation control device 100 provides convenient control of the electronic presentation application 250 of the computer 200, because the electronic presentation control device 100 may be a mobile phone, a personal digital assistant (PDA), or another kind of mobile communication device, all of which are already in widespread use. Moreover, by expanding the features and functions of an existing mobile communication device, the mobile communication device can thereby be adapted to constitute the electronic presentation control device 100. The electronic presentation control device 100 eliminates the need for add-on signal transmitters and receivers. Thus the cost of employing the electronic presentation control device 100 is relatively low.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. An electronic presentation control device, comprising:
a keyboard module for inputting information;
a command encoding module for encoding the input information into control information;
a wireless communication module for communicating with a communication port of a computer via a wireless local area network; and
an electronic presentation control module for inputting the control information to the communication port of the computer and controlling an electronic presentation application of the computer.

2. The control device as claimed in claim 1, further comprising a laser pointing light module for emitting light, the laser pointing light module controlled by the keyboard module and the electronic presentation control module.

3. The control device as claimed in claim 1, wherein the input information comprises a plurality of commands comprising first page, last page, next page, and previous page.

4. The control device as claimed in claim 1, wherein the command encoding module comprises American Standard Code for Information Interchange (ASCII) for transforming the input information into the control information.

5. The control device as claimed in claim 1, wherein the electronic presentation control device comprises a mobile phone.

6. The control device as claimed in claim 1, wherein the electronic presentation control device comprises a personal digital assistant.

7. An electronic presentation control system, comprising:
a computer comprising an electronic presentation application for displaying an electronic presentation, and a communication port; and
an electronic presentation control device, comprising:
a keyboard module for inputting information;
a command encoding module for encoding the input information into control information;
a first wireless communication module for communicating with the communication port of the computer via a wireless local area network; and
an electronic presentation control module for inputting the control information to the communication port of the computer and controlling the electronic presentation application of the computer;
wherein the computer receives the modified control information, reads the control information from the communication port, and executes corresponding commands to control the electronic presentation application.

8. The control system as claimed in claim 7, further comprising a projector for projecting presentation information of the electronic presentation application.

9. The control system as claimed in claim 7, further comprising an access point for wirelessly interconnecting the computer and the electronic presentation control device.

10. The control system as claimed in claim 7, wherein the electronic presentation control module further comprises a laser pointing light module for emitting light, the laser pointing light module controlled by the keyboard module and the electronic presentation control module.

11. The control system as claimed in claim 7, wherein the input information comprises a plurality of commands comprising first page, last page, next page, and previous page, corresponding to the electronic presentation application of the computer.

12. The control system as claimed in claim 7, wherein the command encoding module comprises American Standard Code for Information Interchange (ASCII) for transforming the input information into the control information.

13. The control system as claimed in claim 7, wherein the computer further comprises a second wireless communication module for receiving the modified control information from the first wireless communication module.

14. The control system as claimed in claim 13, wherein the computer further comprises a drive module for actuating the communication port and reading the control information from the communication port.

15. The control system as claimed in claim 14, wherein the computer further comprises a command decoding module for decoding the control information into the original input information.

16. The control system as claimed in claim 15, wherein the computer further comprises a keyboard drive module for analyzing the input information and executing corresponding commands to control the electronic presentation application.

17. An electronic presentation control method, comprising the steps of: executing a drive application on a computer to actuate a communication port of the computer;
providing an electronic presentation control device for executing an electronic presentation control application;
setting an internet protocol address and the communication port of the computer; connecting the electronic presentation control device and the computer via a wireless communication network;
inputting the control information via the electronic presentation control application to the communication port of the computer;
transmitting modified control information from the electronic presentation control device via the wireless communication network to the computer; and
receiving the modified control information, the drive application reading the control information from the communication port, and executing corresponding commands to control an electronic presentation application of the computer.

18. The control method as claimed in claim 17, wherein the inputting step comprises receiving input information, encoding the input information into the control information, and inputting the control information via the electronic presentation control application to the communication port.

19. The control method as claimed in claim 17, wherein the reading step further comprises decoding the control information into the original input information, and analyzing the input information to execute corresponding commands to control the electronic presentation application.

20. The control method as claimed in claim 18, wherein the input information comprises any one or more commands selected from the group consisting of first page, last page, next page, and previous page, corresponding to the electronic presentation application of the computer.

21. The control method as claimed in claim 18, wherein the encoding step comprises transforming the input information into the control information via American Standard Code for Information Interchange (ASCII).
